(19) United States
(12) Patent Application Publication
(10) Pub. No.: US 2012/0124912 A1
(43) Pub. Date: May 24, 2012

(54) VEHICLE DOOR FRAME AND METHOD OF PRODUCING THE SAME

(75) Inventors: Takayuki OKADA, Chiryu-shi (JP); Kenji Shimizu, Toyokawa-shi (JP); Jun Makita, Nukata-gun (JP); Kazuyoshi Yokota, Gamagori-shi (JP)

(73) Assignee: SHIROKI CORPORATION, Fujisawa-shi (JP)

(21) Appl. No.: 13/298,478

(22) Filed: Nov. 17, 2011

(30) Foreign Application Priority Data
Nov. 19, 2010 (JP) 2010-258756

(51) Int. Cl. B60J 5/04

(52) U.S. Cl. 49/501; 49/506

(57) ABSTRACT

A vehicle door frame includes a sash frame that forms a vehicle door frame body and a bracket joined to the sash frame, wherein the sash frame and the bracket are made to mutually overlap each other so that an edge portion of one of the sash frame and the bracket is positioned on the other of the sash frame and the bracket. The sash frame and the bracket are fixed to each other at the edge portion by welding, thereby forming a welded portion thereat. The sash frame and the bracket are fixed to each other by an adhesive injected in between opposed surfaces of the mutually overlapping portions of the sash frame and the bracket, thereby forming an adhesion portion thereat. A method of producing such a vehicle door frame is also disclosed.

### BACKGROUND OF THE INVENTION

1. Field of the Invention The present invention relates to a vehicle door frame and a method of producing the vehicle door frame.

2. Description of Related Art

Vehicle door frames are basically provided with a sash frame that forms a vehicle door frame body and two (front and rear) brackets that are respectively joined to the lower front and the lower rear of the sash frame. Conventionally, the sash frame and each bracket have been joined to each other in a mutually overlapping state by welding at a plurality of positions. This conventional structure is disclosed in Japanese Unexamined Patent Publication H11-77320.

However, according to the inventors of the present invention, the above described conventional welding technique, in which the sash frame and each bracket are joined merely by welding, has some problems which will be discussed hereinafter.

Firstly, there is possibility of the vehicle door frame being thermally distorted (strained) if the sash frame and each bracket are joined by welding at an increased number of welding positions to enhance the strength of joint between the sash frame and each bracket.

Secondly, when the times required for a number of the manufacturing processes performed in the production line of a vehicle door frame are mutually compared, it can be seen that the time required for the process of welding the brackets to the sash frame is longer than the time required for any other process, thus causing congestion in the production line at the stage of the welding process. This congestion increases the entire manufacturing time (Takt time) of the vehicle door frame, thus deteriorating the operating efficiency of the production line. The time required for the welding process becomes longer especially when a light metallic material such as an aluminum alloy is used instead of an iron-based material. This is because the sash frame and the brackets need to be held traversely (horizontally) since a light metallic material easily melts and runs when welding is carried out and because welding needs to be carried out on both sides of the sash frame and brackets to increase the strength of joint between the sash frame and each bracket, which requires extra time for changing the orientation of the sash frame and brackets (turning over to the other side from a horizontal holding state).

### SUMMARY OF THE INVENTION

The present invention has been devised in view of the above described problems of the prior art and provides a vehicle door frame exhibits minimal thermal distortion upon welding and which only requires a short time for the welding process. The present invention further provides a method of producing such a vehicle door frame.

Upon reviewing a conventional technical manner in which a sash frame and each bracket are joined only by a welding operation, the present invention has been devised with focus on using an adhesive together with a welding operation in order to join a bracket(s) to a sash frame.

According to an aspect of the present invention, a vehicle door frame is provided, including a sash frame that forms a vehicle door frame body and a bracket joined to the sash frame, wherein the sash frame and the bracket are made to mutually overlap each other so that an edge portion of one of the sash frame and the bracket is positioned on the other of the sash frame and the bracket. The sash frame and the bracket are fixed to each other at the edge portion by welding, thereby forming a welded portion thereat. The sash frame and the bracket are fixed to each other by an adhesive injected in between opposed surfaces of the mutually overlapping portions of the sash frame and the bracket, thereby forming an adhesion portion thereat.

In the case where a front bracket and a rear bracket are joined to the lower front and the lower rear of the sash frame, respectively, it is possible for welding and adhesive joining be used in combination to join the front bracket (or the rear bracket) and the sash frame to each other while only welding is used to join the rear bracket (or the front bracket) and the sash frame to each other.

As mentioned above, in the case where the sash frame and the bracket(s) are each made of a light metallic material such as an aluminum alloy, the sash frame and the bracket(s) need to be held traversely (horizontally) to prevent melted metal from running when welding is carried out; in addition, welding needs to be carried out on both sides of the sash frame and the bracket(s) by turning the sash frame and the bracket(s) over to the other side (upside down). However, an apparatus required to achieve such a change in orientation of the sash frame and bracket(s) (i.e., to turn the sash frame and the bracket over) is large in scale and costly; in addition, the time required for the welding process becomes longer if extra time is required for changing the orientation of the sash frame and bracket(s).

To overcome such drawbacks, it is desirable that the sash frame and the bracket are each made of a light metallic material, and that the welded portion is formed only on one side of the vehicle door frame (to eliminate the process of turning the sash frame and the bracket which are held traversely (horizontally) at the welding step upside down).

It is desirable for a distance between the sash frame and the bracket at the adhesion portion is greater than a distance between the sash frame and the bracket at the welded portion.

This structure makes it possible to inject a sufficient amount of adhesive in between opposed surfaces of the sash frame and the bracket, thus making it possible to obtain a joint strength substantially equivalent to that between a sash frame and a bracket which are joined to each other only by welding in a conventional manner.

It is desirable for the welded portion and the adhesion portion to be offset from each other in one of a first direction in which the sash frame and the bracket are made to overlay each other and a second direction orthogonal to the first direction.

By offsetting the adhesion portion and the welded portion in such a manner, the strength of the joint between the sash frame and the bracket can further be increased.

It is desirable for one of the sash frame and the bracket to include a visual inspection hole, formed in at least one of the sash frame and the bracket, for visual inspection of a space between the opposed surfaces of the mutually overlapping portions of the sash frame and the bracket.

With this structure, it is possible to visually check through the visual inspection hole whether or not the adhesive has spread across the gap between the opposed surfaces of the sash frame and the bracket that are made to overlap each other.

The edge portion can be a plate-thickness edge of one of the sash frame and the bracket. Alternatively (additionally), the edge portion can be a corner section of one of the sash frame and the bracket.

It is desirable for the vehicle door frame to include a belt-line reinforcing member which is positioned below the sash frame, the bracket being joined between the sash frame and the belt-line reinforcing member.

According to another aspect of the present invention, a method of producing a vehicle door frame is provided, including a sash frame that forms a vehicle door frame body and a bracket joined to the sash frame, the method including making the sash frame and the bracket overlap each other so that an edge portion of one of the sash frame and the bracket is positioned on the other of the sash frame and the bracket, fixing the sash frame and the bracket to each other by welding at the edge portion, injecting a thermosetting adhesive in between opposed surfaces of the sash frame and the bracket, and thermally curing the thermosetting adhesive.

The step of welding the sash frame and the bracket is performed in the welding process in a factory production line, whereby the sash frame and the bracket are temporarily joined to each other to thereby be positioned relative to each other. The step of injecting a thermosetting adhesive is also performed in the same factory production line after completion of the welding step. By performing the thermosetting-adhesive injecting step after the welding step, accidental ignition of the thermosetting adhesive can be prevented from occurring. In addition, the thermosetting adhesive can be prevented from changing in quality due to welding heat input, and the bonding capability of the thermosetting adhesive can be prevented from deteriorating due to adhesion of spatter or smut to the thermosetting adhesive which occurs when welding is performed. The step of thermally curing the injected thermosetting adhesive can be performed using heat produced for drying paint in a painting process performed in a factory production line, so that no additional process for thermally curing the thermosetting adhesive is required. Alternatively, a heating and curing step for thermally curing the thermosetting adhesive can be provided after the thermosetting-adhesive injecting step.

According to the present invention, a vehicle door frame which exhibits minimal thermal distortion upon welding and which requires only a short period of time for the welding process can be achieved; and furthermore, a method of producing such a vehicle door frame can be achieved.

The present disclosure relates to subject matter contained in Japanese Patent Application No. 2010-258756 (filed on Nov. 19, 2010) which is expressly incorporated herein by reference in its entirety.

### BRIEF DESCRIPTION OF THE DRAWINGS

The present invention will be discussed below in detail with reference to the accompanying drawings, in which:

FIG. 1 is a front elevational view of an embodiment of vehicle door frame, viewed from the vehicle interior side;

FIG. 2 is a cross sectional view taken along the line II-II shown in FIG. 1;

FIG. 3 is a cross sectional view taken along the line shown in FIG. 1;

FIG. 4 is a cross sectional view taken along the line IV-IV shown in FIG. 1;

FIG. 5 is a cross sectional view taken along the line V-V shown in FIG. 1;

FIG. 6 is a cross sectional view taken along the line VI-VI shown in FIG. 1; and

FIG. 7 is a diagram showing an example of a structure which facilitates injection of a thermosetting adhesive in between opposed surfaces of a sash frame and a bracket.

### DESCRIPTION OF THE EMBODIMENTS

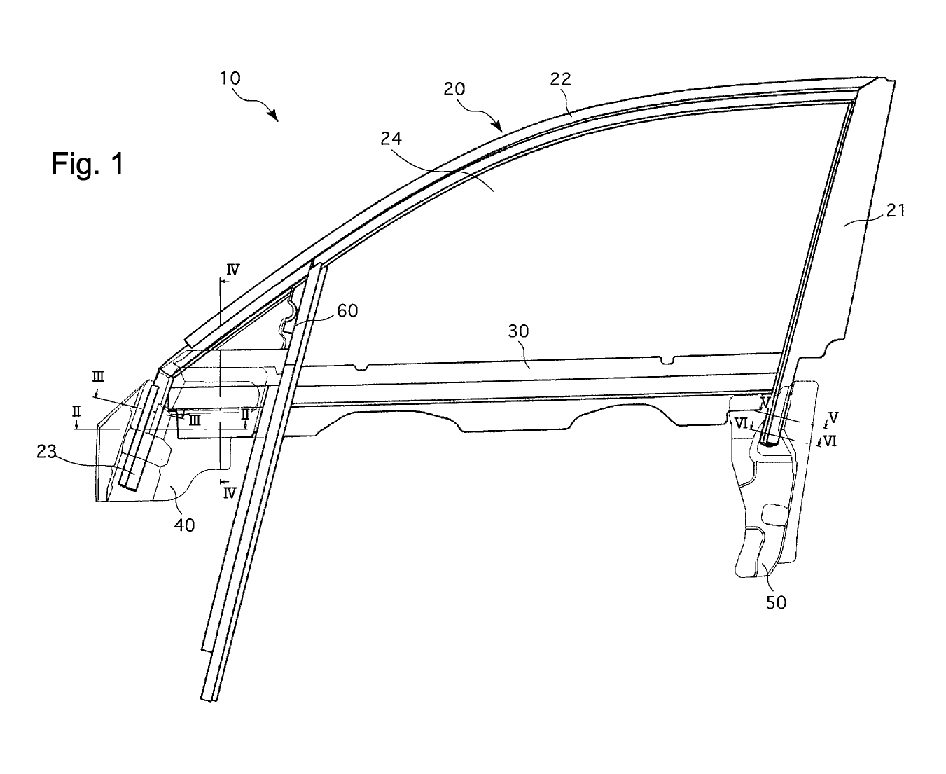

An embodiment of a door frame (vehicle door frame) 10 made of a light metallic material such as an aluminum alloy, to which a method of producing a vehicle door frame according to the present invention has been applied, will be discussed with reference to FIGS. 1 through 6. The door frame 10 is that of a front door for a front seat of an automobile (vehicle), and the term “forward/rearward direction” in the following descriptions denotes the forward/rearward direction of the door frame 10. However, the present invention can be applied not only to the door frame of a front door for a vehicle front seat but also to the door frame of a rear door for a vehicle rear seat, and even to the door frame of any other door.

The door frame 10 constitutes a door frame body having an approximately triangular shape which includes a sash frame 20, and a belt-line reinforcing member 30 that is positioned immediately below the sash frame 20 and extends in the forward/rearward direction. The door frame 10 is provided at the lower front corner thereof with a front bracket (bracket) 40 that is joined between the sash frame 20 and the belt-line reinforcing member 30, and is provided at the lower rear corner of the door frame 10 with a rear bracket (bracket) 50 that is joined between the sash frame 20 and the belt-line reinforcing member 30.

The sash frame 20 is provided with an upright sash 21, an upper sash 22 and a front sash 23. The upright sash 21 extends substantially in the vertical direction of the door frame 10 (the upward/downward direction with respect to FIG. 1). The upper sash 22 that forms the upper edge of the door is joined at the rear end thereof to the upper edge of the upright sash 21, while the front sash 23 is joined to the front end of the upper sash 22. The front bracket 40 is joined to a lower front of the upper sash 22 and the front sash 23, and a portion of the front end of the belt-line reinforcing member 30 is joined to the front bracket 40. The rear bracket 50 is joined at a lower portion of the upright sash 21 and a portion of the rear end of the belt-line reinforcing member 30 is joined to the rear bracket 50. The front bracket 40 and the rear bracket 50 are secured to a door panel (inner panel), not shown in the drawings, which constitutes a door body. The front bracket 40 also serves as a mirror bracket for mounting a front door mirror. The sash frame 20 forms a window opening 24 that is surrounded by the upright sash 21 and the upper sash 22, and a window door glass (not shown) slides up and down in the window opening 24. The belt-line reinforcing member 30 is installed to extend along the upper edge of the door panel (inner panel), not shown in the drawings. The door frame 10 is provided with a division bar 60 which is joined to portions of the upper sash 22 and the belt-line reinforcing member 30 in the vicinity of the front ends thereof. The division bar 60 extends substantially in the vertical direction of the door frame 10 and partitions the window opening 24 into front and rear sections. The above described elements of the door frame 10 are made as molded products, each molded of a light metallic material such as an aluminum alloy.

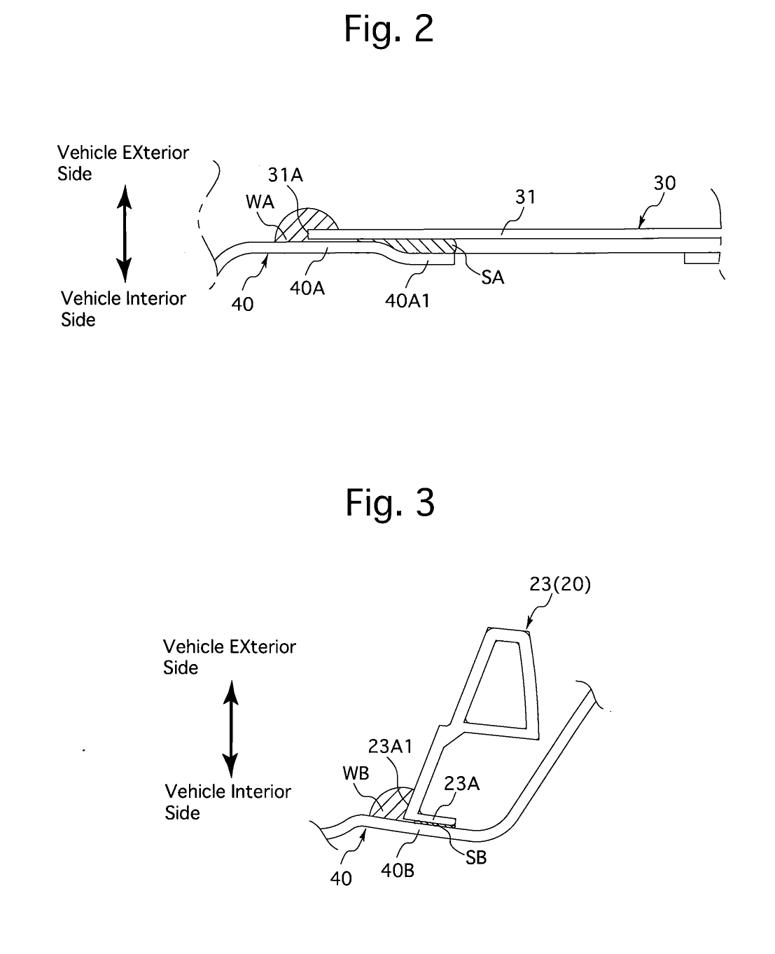

The embodiment which will be discussed below relates to the joining structure between the sash frame (the sash frame 20 and the belt-line reinforcing member 30) that forms a door frame body of the door frame 10 and the brackets (the front bracket 40 and the rear bracket 50); the details of this joining structure will be hereinafter discussed with reference to FIGS. 2 through 6.

FIG. 2 shows a cross section of the joint between the belt-line reinforcing member 30 and the front bracket 40 taken along the line II-II shown in FIG. 1. In the cross section shown in FIG. 2, the belt-line reinforcing member 30 and the front bracket 40 are positioned to overlap each other as viewed from the vehicle exterior side with an edge portion 31A of the belt-line reinforcing member 30, which is an end (plate-thickness edge) of a planar overlapping portion 31 of the belt-line reinforcing member 30, positioned on a planar overlapping portion 40A of the front bracket 40, and a welded portion (weld zone) WA is formed on the edge portion 31A. The planar overlapping portion 40A of the front bracket 40 is provided with an offset portion 40A1 that is offset toward the vehicle interior side (downward with respect to FIG. 2) with respect to the remaining part of the planar overlapping portion 40A, and an adhesion portion SA is formed between opposed surfaces of the planar overlapping portion 40A (which includes the offset portion 40A1) and the planar overlapping portion 31. Accordingly, the distance (gap) between the belt-line reinforcing member 30 and the front bracket 40 in the adhesion portion SA is greater than that between the belt-line reinforcing member 30 and the front bracket 40 in the welded portion WA. This makes it possible to form a sufficient amount of the adhesion portion SA between opposed surfaces of the belt-line reinforcing member 30 and the front bracket 40, so that a joint strength substantially equivalent to that in the case where the belt-line reinforcing member 30 and the front bracket 40 are joined to each other only by welding can be obtained. In addition, the strength of joint between the belt-line reinforcing member 30 and the front bracket 40 can be increased since the welded portion WA and the adhesion portion SA are offset in the overlaying direction (upward/downward direction with respect to FIG. 2) between the belt-line reinforcing member 30 and the front bracket 40 and a direction orthogonal to this overlaying direction (the leftward/rightward (overlapping) direction with respect to FIG. 2).

FIG. 3 shows a cross section of the joint between the front sash 23 and the front bracket 40 taken along the line III-III shown in FIG. 1. In the cross section shown in FIG. 3, the front sash 23 and the front bracket 40 are positioned to overlap each other as viewed from the vehicle exterior side with an edge portion (corner section) 23A1 of the front sash 23 (which is formed by bending a planar overlapping portion 23A of the front sash 23) positioned on a planar overlapping portion 40B of the front bracket 40, and a welded portion (weld zone) WB is formed on the edge portion 23A1 of the front sash 23. An adhesion portion SB is formed between opposed surfaces of the planar overlapping portion 40B and the planar overlapping portion 23A.

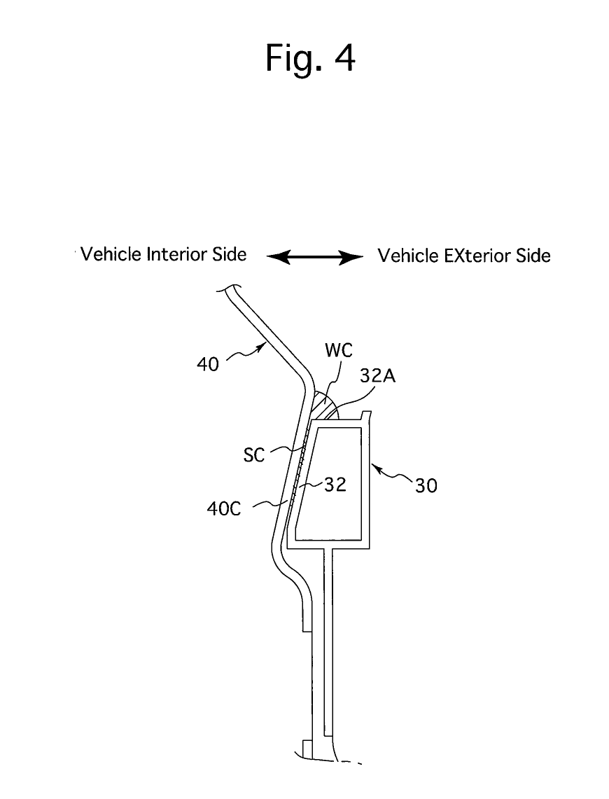

FIG. 4 shows a cross section of the joint between the belt-line reinforcing member 30 and the front bracket 40 taken along the line IV-IV shown in FIG. 1. In the cross section shown in FIG. 4, the belt-line reinforcing member 30 and the front bracket 40 are positioned to overlap each other as viewed from the vehicle exterior side with an edge portion (corner section) 32A of a box-shaped hollow section (pocket) 32 of the belt-line reinforcing member 30 positioned on a planar overlapping portion 40C of the front bracket 40, and a welded portion (weld zone) WC is formed on the edge portion 32A. An adhesion portion SC is formed between opposed surfaces of the planar overlapping portion 40C and the box-shaped hollow section 32.

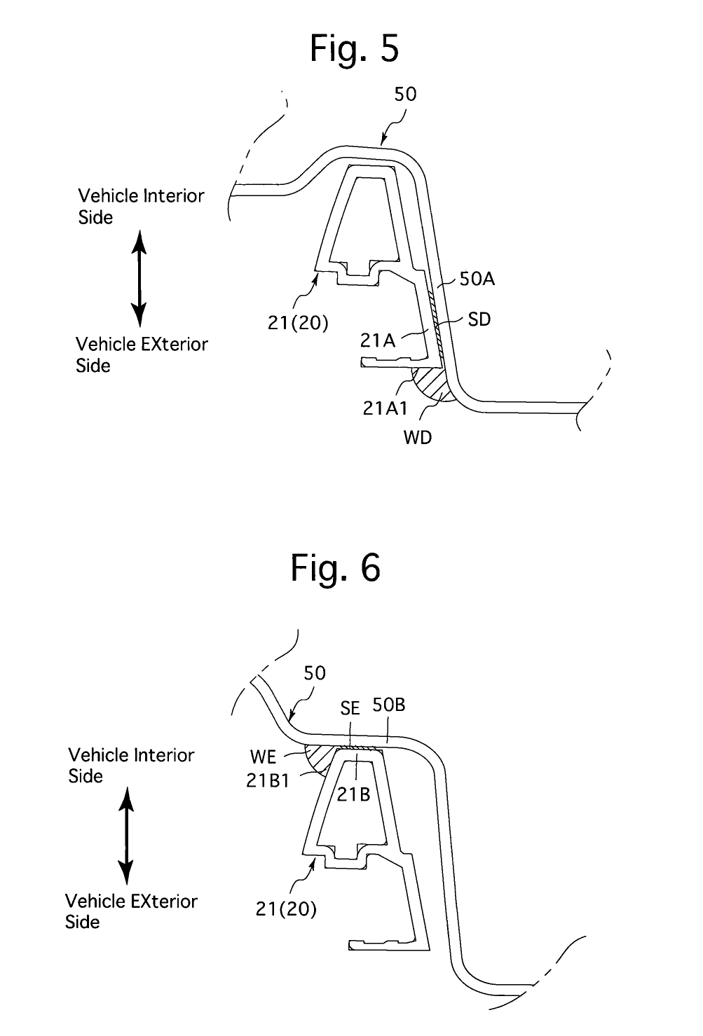

FIG. 5 shows a cross section of the joint between the upright sash 21 and the rear bracket 50 taken along the line V-V shown in FIG. 1. In the cross section shown in FIG. 5, the upright sash 21 and the rear bracket 50 are positioned to overlap each other as viewed from the vehicle exterior side with an edge portion (corner section) 21A1 of the upright sash 21 (which is formed by bending a planar overlapping portion 21A of the upright sash 21) positioned on a planar overlapping portion 50A of the rear bracket 50, and a welded portion WD is formed on the edge portion 21A1 of the upright sash 21. An adhesion portion SD is formed between opposed surfaces of the planar overlapping portion 50A and the planar overlapping portion 21A.

FIG. 6 shows a cross section of the joint between the upright sash 21 and the rear bracket 50. In the cross section shown in FIG. 6, the upright sash 21 and the rear bracket 50 are positioned to overlap each other as viewed from the vehicle exterior side with an edge portion (corner section) 21B1 of a box-shaped hollow section (pocket) 21B of the upright sash 21 positioned on a planar overlapping portion 50B of the rear bracket 50, and a welded portion WE is formed on the edge portion 21B1. An adhesion portion SE is formed between opposed surfaces of the planar overlapping portion 50B and the box-shaped hollow section 21B.

The adhesion portions SA, SB, SC, SD and SE in FIGS. 2 through 6 are each formed by thermally curing a thermosetting adhesive such as an Orotex (registered trade mark) adhesive. In addition, the welded portions (weld zones) WA, WB, WC, WD and WE and the adhesion portions SA, SB, SC, SD and SE are formed to be spaced apart from each other in a direction normal to the planes of FIGS. 2 through 6, respectively. Although the welded portions WA, WB, WC, WD and WE and the adhesion portions SA, SB, SC, SD and SE are illustrated in the same cross sectional position in FIGS. 2 through 6, respectively, the positions of each welded portion and the associated adhesion portion can be shifted from each other in a direction normal to the plane of the page (i.e., it is practical/convenient for them to be shifted from each other in this normal direction).

Accordingly, in the present embodiment of the door frame, the sash frame (20) and each bracket (40 and 50) are made to overlap each other with an edge portion of one of the sash frame and the bracket positioned on the other, and are fixed to each other at this edge portion by welding and fixed to each other by an adhesive injected in between opposed surfaces of the mutually overlapping portions of the sash frame and each bracket. Accordingly, since weld joining by the welded portion (WA, WB, WC, WD and WE) and adhesive joining (SA, SB, SC, SD and SE) are used in combination to join the sash frame with each bracket, the number of welded portions can be reduced, which consequently results in a reduction of thermal distortion caused by welding and makes it possible to achieve a reduction of the time required for the welding process.

A method of producing the door frame 10, which is constructed as described above, in a factory production line will be discussed hereinafter. First, the upright sash 21, the upper sash 22 and the front sash 23 are molded and joined together to complete the sash frame 20. In addition, the belt-line reinforcing member 30, the front bracket 40 and the rear bracket 50 are molded.

Subsequently, in a state where the sash frame (the sash frame 20 and the belt-line reinforcing member 30) and each bracket (the front bracket 40 and the rear bracket 50) are laid overlapping each other with the exterior sides thereof facing upward, these elements are held traversely (horizontally) using a horizontal holding mechanism (jig), not shown in the drawings. In this overlapping state, the edge portion 31A, which is an end (plate-thickness edge) of the planar overlapping portion 31 of the belt-line reinforcing member 30, lies on the planar overlapping portion 40A of the front bracket 40 (see FIG. 2), the edge portion (corner section) 23A1 of the front sash 23 (which is formed by bending the planar overlapping portion 23A of the front sash 23) lies on the planar overlapping portion 40B of the front bracket 40 (see FIG. 3), the edge portion (corner section) 32A of the box-shaped hollow section (pocket) 32 of the belt-line reinforcing member 30 lies on the planar overlapping portion 40C of the front bracket 40 (see FIG. 4), the edge portion (corner section) 21A1 of the upright sash 21 that is formed by bending the planar overlapping portion 21A of the upright sash 21 lies on the planar overlapping portion 50A of the rear bracket 50 (see FIG. 5), and the edge portion (corner section) 21B1 of the box-shaped hollow section (pocket) 21B of the upright sash 21 lies on the planar overlapping portion 50B of the rear bracket 50 (see FIG. 6).

Subsequently, welding is performed on the edge portions 31A, 23A1, 32A, 21A1 and 21B1 to form the welded portions WA, WB, WC, WD and WE, respectively. This welding step causes the sash frame (the sash frame 20 and the belt-line reinforcing member 30) and each bracket (the front bracket 40 and the rear bracket 50) to be temporarily joined to each other to thereby be correctly positioned relative to each other since welding becomes effective immediately.

After completion of the welding step, a thermosetting adhesive is injected in between opposed surfaces of the planar overlapping portion 40A and the planar overlapping portion 31 (see FIG. 2), between opposed surfaces of the planar overlapping portion 40B and the planar overlapping portion 23A (see FIG. 3), between opposed surfaces of the planar overlapping portion 40C and the box-shaped hollow section 32 (FIG. 4), between opposed surfaces of the planar overlapping portion 50A and the planar overlapping portion 21A (FIG. 5), and between opposed surfaces of the planar overlapping portion 50B and the box-shaped hollow section 21B (FIG. 6). As an example of the thermosetting adhesive, an Orotex (registered trade mark) adhesive or the like can be used. An injection nozzle is inserted in between each pair of the aforementioned pairs of opposed surfaces to inject the thermosetting adhesive therein. At this stage, the thermosetting adhesive is not yet cured, thus hardly contributing to the joining of the sash frame 20 with the front bracket 40 and the rear bracket 50 at all.

However, by performing this thermosetting-adhesive injecting step after the above described welding step, accidental ignition of the thermosetting adhesive can be prevented from occurring. In addition, the thermosetting adhesive can be prevented from changing in quality due to welding heat input, and also the bonding capability of the thermosetting adhesive can be prevented from deteriorating due to adhesion of spatter or smut to the thermosetting adhesive which would otherwise occur when welding is performed. The timing of performing the thermosetting-adhesive injecting step can be freely set at any point after completion of the welding step.

Thereafter, the process of applying paint to the door frame 10 and drying this paint is performed. Due to the heat produced in this painting process to dry the paint applied to the door frame 10, the thermosetting adhesive injected in between opposed surfaces of the sash frame (the sash frame 20 and the belt-line reinforcing member 30) and each bracket (the front bracket 40 and the rear bracket 50) is thermally cured to form the adhesion portions SA, SB, SC, SD and SE. As a consequence, the sash frame 20 and each of the front bracket 40 and the rear bracket 50 are joined to each other also by the adhesion portions SA, SB, SC, SD and SE in addition to the welded portions WA, WB, WC, WD and WE. Hence, no additional process for thermally curing the thermosetting adhesive is required in the present embodiment.

The method of producing the above described embodiment of the vehicle door frame includes a step of making a sash frame and a bracket overlap each other with an edge portion of one of the sash frame and the bracket positioned on the other, a step of fixing the sash frame and the bracket to each other by welding at the edge portion, a step of injecting a thermosetting adhesive in between opposed surfaces of the sash frame and the bracket, and a step of thermally curing the injected thermosetting adhesive. Accordingly, since joining via the welding of the welded portions (WA, WB, WC, WD and WE) and joining via the adhering of the adhesive portions (SA, SB, SC, SD and SE) are used in combination to join the sash frame and the bracket to each other, the number of welded portions can be reduced, which consequently results in a reduction of thermal distortion caused by welding and makes it possible to reduce the time required for the welding process.

Additionally, according to the method of producing the above described embodiment of the vehicle door frame, since the sash frame and the front and rear brackets are joined by the adhesion portions SA, SB, SC, SD and SE that are formed by thermally curing thermosetting adhesive, welding does not have to be again performed in a state where the sash frame and each bracket are laid overlapping each other with the interior sides thereof facing upward, which makes it possible to eliminate the process of turning (a combination of) the sash frame and the brackets which are held traversely (horizontally) at the welding step over to the other side, thus making it possible to achieve a reduction in the size of the factory production line and also a reduction in the production cost. Additionally, no extra time for performing this turning-over process is required, which makes it possible to make the production line operate efficiently by reducing to a minimum the time required for the stage of the welding process.

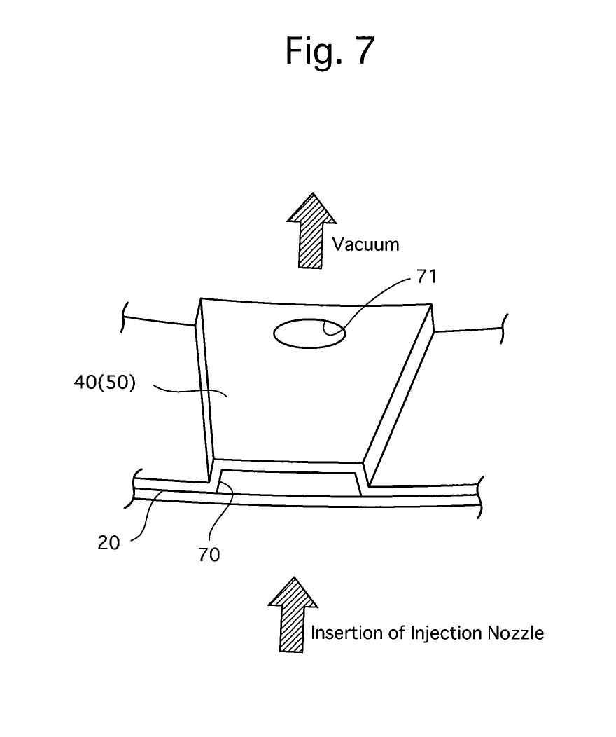

FIG. 7 shows an example of a structure which makes a thermosetting adhesive easier to inject in between opposed surfaces of the sash frame 20 and the bracket 40 (50). In this example, the door frame is structure to make the thermosetting adhesive easy to spread across the gap between the opposed surfaces of the sash frame 20 and the bracket 40(50) by forming opposed surfaces of the sash frame 20 and the bracket 40(50) so that the width thereof increases in a direction toward the far end (upward with respect to FIG. 7) from an insertion opening 70 through which the aforementioned injection nozzle for injection of a thermosetting adhesive is inserted while vacuuming this thermosetting adhesive from the other side of the insertion opening 70. Additionally, by forming a visual inspection hole 71 in the bracket 40(50) as shown in FIG. 7, it is possible to visually check through the visual inspection hole 71 whether or not the thermosetting adhesive has spread in between the opposed surfaces of the sash frame 20 and the bracket 40(50).

Although the present invention has been illustrated and described above with reference to the case where a door frame devised according to the present invention and the method of producing the same door frame are applied to a door frame made of a light metallic material such as an aluminum alloy, the present invention is also applicable to a door frame made of another metal such as an iron-based material.

Obvious changes may be made in the specific embodiments of the present invention described herein, such modifications being within the spirit and scope of the invention claimed. It is indicated that all matter contained herein is illustrative and does not limit the scope of the present invention.

What is claimed is:

1. A vehicle door frame including a sash frame that forms a vehicle door frame body and a bracket joined to said sash frame,
wherein said sash frame and said bracket are made to mutually overlap each other so that an edge portion of one of said sash frame and said bracket is positioned on the other of said sash frame and said bracket,
wherein said sash frame and said bracket are fixed to each other at said edge portion by welding, thereby forming a welded portion thereat, and
wherein said sash frame and said bracket are fixed to each other by an adhesive injected in between opposed surfaces of the mutually overlapping portions of said sash frame and said bracket, thereby forming an adhesion portion thereat.

2. The vehicle door frame according to claim 1, wherein said sash frame and said bracket are each made of a light metallic material, and
wherein said welded portion is formed only on one side of said vehicle door frame.

3. The vehicle door frame according to claim 1, wherein a distance between said sash frame and said bracket at said adhesion portion is greater than a distance between said sash frame and said bracket at said welded portion.

4. The vehicle door frame according to claim 1, wherein said welded portion and said adhesion portion are offset from each other in one of a first direction in which said sash frame and said bracket are made to overlay each other and a second direction orthogonal to said first direction.

5. The vehicle door frame according to claim 1, wherein one of said sash frame and said bracket comprises a visual inspection hole, formed in at least one of said sash frame and said bracket, for visual inspection of a space between said opposed surfaces of said mutually overlapping portions of said sash frame and said bracket.

6. The vehicle door frame according to claim 1, wherein said edge portion comprises a plate-thickness edge of one of said sash frame and said bracket.

7. The vehicle door frame according to claim 1, wherein said edge portion comprises a corner section of one of said sash frame and said bracket.

8. The vehicle door frame according to claim 1, comprising a belt-line reinforcing member which is positioned below said sash frame, said bracket being joined between said sash frame and said belt-line reinforcing member.

9. A method of producing a vehicle door frame including a sash frame that forms a vehicle door frame body and a bracket joined to said sash frame, said method comprising:
making said sash frame and said bracket overlap each other so that an edge portion of one of said sash frame and said bracket is positioned on the other of said sash frame and said bracket;
fixing said sash frame and said bracket to each other by welding at said edge portion;
injecting a thermosetting adhesive in between opposed surfaces of said sash frame and said bracket; and
thermally curing said thermosetting adhesive.
